(19) United States
(12) Patent Application Publication
(10) Pub. No.: US 2014/0333672 A1
(43) Pub. Date: Nov. 13, 2014

(54) DATA CONVERSION APPARATUS AND METHOD

(71) Applicant: Almondsoft Co., Ltd., Seoul (KR)

(72) Inventors: Jinho Jang, Seoul (KR); Kumhee Hwang, Seoul (KR)

(73) Assignee: ALMONDSOFT CO., LTD., Seoul (KR)

(21) Appl. No.: 14/140,429

(22) Filed: Dec. 24, 2013

(30) Foreign Application Priority Data
May 8, 2013 (KR) 10-2013-0051876

(51) Int. Cl. G06T 3/40

(52) U.S. Cl. CPC G06T 3/40
USPC 345/660

(57) ABSTRACT

Disclosed herein are a data conversion apparatus and method wherein metadata related to a game used in a feature phone having low resolution is used without change and only an image of the game is converted according to a specific resolution conversion magnification in displaying an image, displayed on a screen of the feature phone, on a screen of a smart phone having high resolution.

### CROSS REFERENCE TO RELATED APPLICATION

This patent document claims the benefit of priority of Korean Patent Application No. 10-2013-0051876, filed in the Korean Intellectual Property Office on May 8, 2013. The entire content of the before-mentioned patent application is incorporated by reference as part of the disclosure of this document.

### BACKGROUND OF THE INVENTION

1. Technical Field

The present invention relates to a data conversion apparatus and method and, more particularly, to a data conversion apparatus and method which are capable of displaying an image, displayed on a screen having specific resolution, on a screen having different resolution and also preventing the displayed image from being distorted.

More particularly, the present invention relates to a data conversion apparatus and method wherein metadata related to a game used in a feature phone having low resolution is used without change and only an image of the game is converted according to a specific resolution conversion magnification in displaying an image, displayed on a screen of the feature phone, on a screen of a smart phone having high resolution.

2. Description of the Related Art

With the recent development of the game industry, a user can enjoy a game even in portable electronic devices, such as a smart phone, a tablet PC, and a laptop, as well as at home.

A number of mobile games that can be played in a feature phone of low resolution have been developed for a screen having 480*320 resolution. As a screen for a smart phone having 960*640 resolution to full High Definition (HD) 1920*1080 resolution is developed, a number of mobile games for high resolution have recently been developed.

As many users want to play games for existing low-resolution feature phones in high-resolution smart phones, game companies release games for smart phones which have been converted from games for feature phones.

In order to convert a game for low resolution into a game for high resolution, the pixels of a game image need to be first converted so as to prevent the distortion of an image attributable to a difference between the pixels of screens. Furthermore, metadata indicating the positions of pixels on a screen also need to be inconveniently modified.

For example, as a prior art regarding resolution conversion, Korean Patent Laid-Open Publication No. 10-2013-0032781 discloses a mobile terminal and an LCD resolution compatibility method for the mobile terminal. The prior art has an advantage in that it can display an application image irrespective of the size of an LCD because it magnifies an application image according to actual LCD resolution if the application resolution is different from the LCD resolution and displays a magnified image.

The conventional LCD resolution compatibility method, however, is problematic in that (i) the overall image is the same, but a contour line and a color difference are not clear and thus image quality is low because an application image of low resolution is magnified according to an LCD screen of high resolution and (ii) an image can be magnified as large as a screen, but an unnecessary blank is generated at the edge of an image because only the entire size of an LCD screen not the metadata of an application is taken into consideration.

In order to solve the problems of the conventional LCD resolution compatibility method, the inventors of the present invention have contrived a data conversion apparatus and method which convert only an image of a game, displayed on a screen of an existing feature phone having low resolution, according to a specific resolution conversion magnification without converting metadata regarding the game used in the feature phone in displaying the image of the game on a screen of a smart phone having high resolution.

### PRIOR ART DOCUMENT

### Patent Document

(Patent Document 1) Korean Patent Laid-Open Publication No. 10-2013-0032781

### SUMMARY OF THE INVENTION

The present invention has been made keeping in mind the above problems occurring in the prior art, and an object of the present invention is to provide a data conversion apparatus and method which are capable of displaying an image, displayed on a screen having specific resolution, on a screen having different resolution and also preventing the displayed image from being distorted.

Another object of the present invention is to provide a data conversion apparatus and method, which are capable of changing the overall size of a low-resolution image by changing the number of one or more pixels of the image without magnifying the image itself.

Yet another object of the present invention is to provide a data conversion apparatus and method which are capable of using metadata used in a low-resolution screen without an additional conversion process and also placing an image related to the metadata in a high-resolution screen without change.

Further yet another object of the present invention is to provide a data conversion apparatus and method wherein the overall size of an image is not reduced by copying and inserting the pixels of the image according to increased resolution using a paging method although the size of each of the pixels is reduced according to the increased resolution.

In accordance with an embodiment of the present invention, a data conversion apparatus includes a pixel processing unit for converting pixels of an image displayed on a first screen having specific resolution so that the pixels are inserted into a plurality of pixels of a second screen having different resolution and a metadata processing unit for processing metadata regarding the pixels of the image displayed on the first screen and placing the image in the second screen based on the metadata so that the image corresponds to a position in the first screen.

Preferably, the pixel processing unit may insert the pixels of the image, displayed on the first screen, into the plurality of pixels of the second screen using a paging method.

Preferably, the pixel processing unit may classify the plurality of pixels of the second screen according to a parameter determined in accordance with Equation below.

V=R² [Equation]

wherein V is the parameter, and R is a conversion magnification of resolution of the second screen for resolution of the first screen.

Preferably, if the image is not magnified, the pixel processing unit may generate one or more non-magnifying groups, corresponding to each of the pixels of the image displayed on the first screen, in the second screen based on the equation, copy each of the pixels of the image displayed on the first screen, and insert the copied pixel into each of the non-magnifying groups.

Preferably, if the image has been magnified, the pixel processing unit may copy each of pixels included in the non-magnifying group according to the parameter and insert the copied pixel into a plurality of pixels of the second screen.

Preferably, the metadata processing unit may include one or more of position data regarding one or more pixels that form the image displayed on the first screen, motion data regarding the motion information of the image, and physical dynamic data for implementing the motion information.

In accordance with an embodiment of the present invention, a data conversion method includes converting pixels of an image displayed on a first screen having specific resolution so that the pixels are inserted into a plurality of pixels of a second screen having different resolution and processing metadata regarding the pixels of the image displayed on the first screen and placing the image in the second screen based on the metadata so that the image corresponds to a position in the first screen.

Preferably, the converting of the pixels of the image may include inserting the pixels of the image, displayed on the first screen, into the plurality of pixels of the second screen using a paging method.

Preferably, the converting of the pixels of the image may include classifying the plurality of pixels of the second screen according to a parameter determined in accordance with Equation below.

V=R² [Equation]

wherein V is the parameter, and R is a conversion magnification of resolution of the second screen for resolution of the first screen.

Preferably, if the image is not magnified, the converting of the pixels of the image may include generating one or more non-magnifying groups, corresponding to each of the pixels of the image displayed on the first screen, in the second screen based on the equation, copying each of the pixels of the image displayed on the first screen, and inserting the copied pixel into each of the non-magnifying groups.

Preferably, if the image has been magnified, the converting of the pixels of the image may include copying each of pixels included in the non-magnifying group according to the parameter and inserting the copied pixel into a plurality of pixels of the second screen.

### BRIEF DESCRIPTION OF THE DRAWINGS

FIG. 1 is a diagram schematically showing a data conversion apparatus in accordance with an embodiment of the present invention;

FIG. 2 shows the construction of the data conversion apparatus in accordance with an embodiment of the present invention;

FIG. 3 is a diagram showing a state in which an image displayed on a first screen according to a pixel processing unit of FIG. 2 has not been magnified;

FIG. 4 is a detailed diagram showing the state of FIG. 3;

FIG. 5 is a diagram showing a state in which an image of a first screen according to the pixel processing unit of FIG. 2 has been magnified; and

FIG. 6 is a detailed diagram showing the state of FIG. 5.

### DETAILED DESCRIPTION

Hereinafter, a data conversion apparatus and method in accordance with some embodiments of the present invention are described with reference to the accompanying drawings. The thickness of lines and the size of elements shown in the drawings may have been enlarged for the clarity of a description and for convenience′ sake. Furthermore, terms to be described later are defined by taking the functions of embodiments of the present invention into consideration, and may be different according to the operator's intention or usage. Accordingly, the terms should be defined based on the overall contents of the specification.

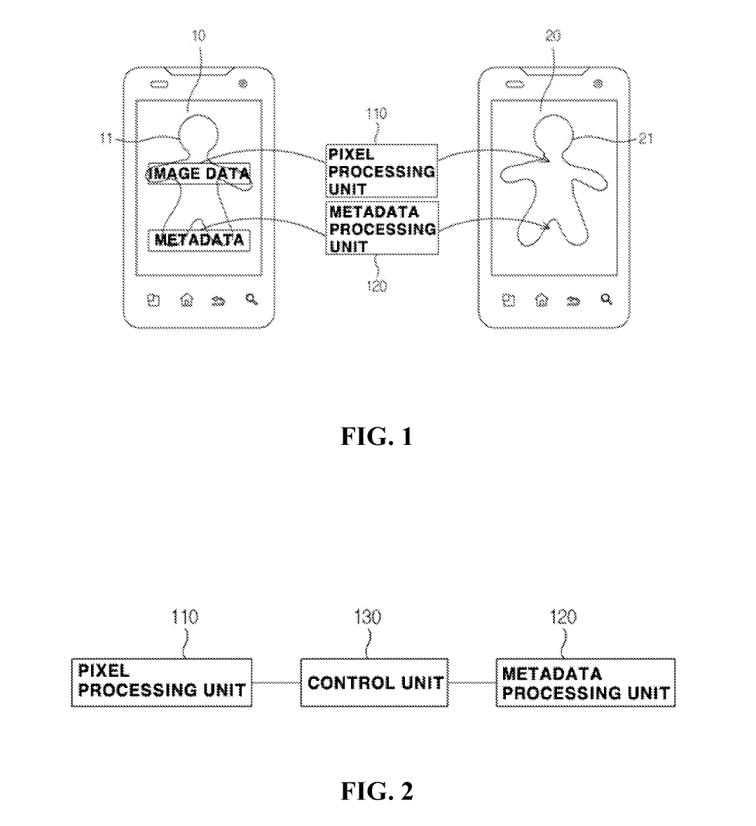

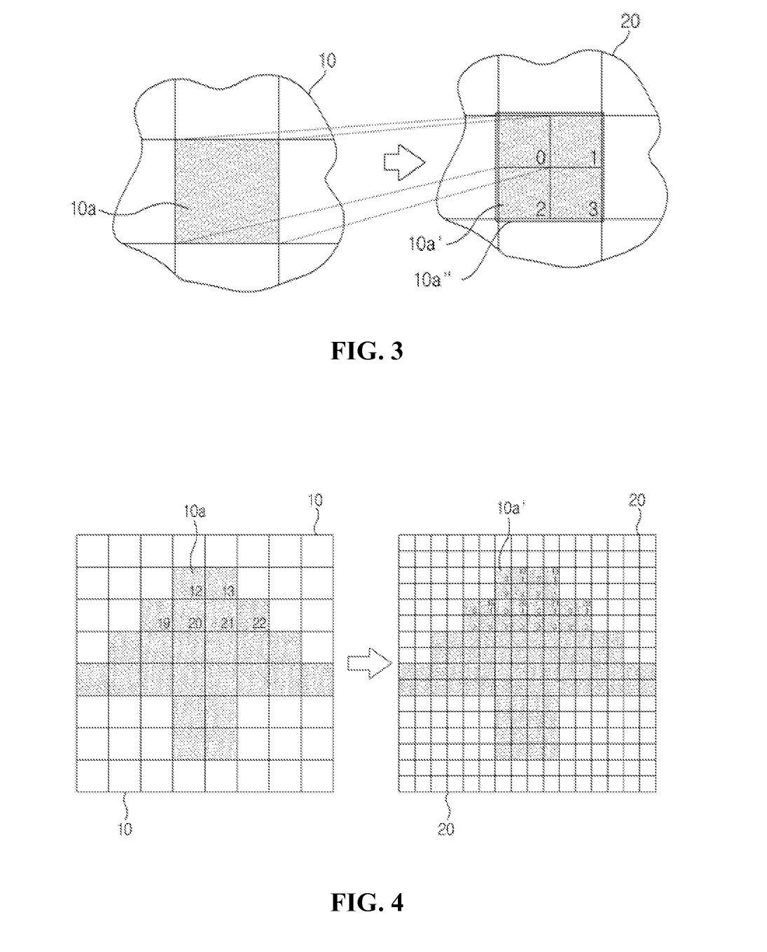

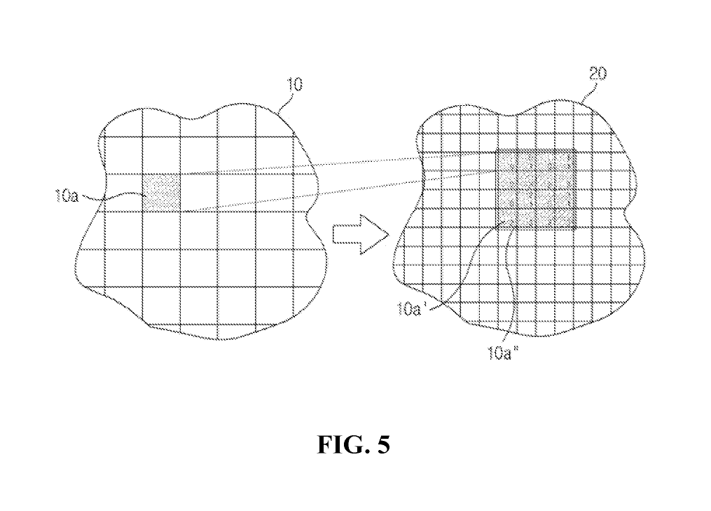

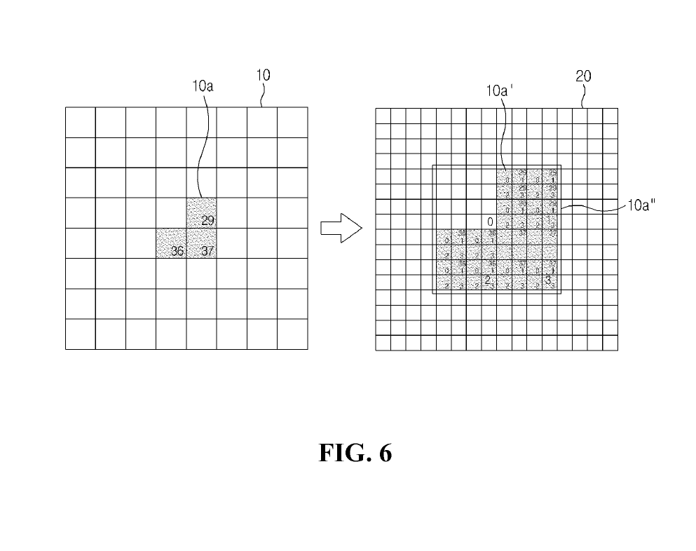

FIG. 1 is a diagram schematically showing a data conversion apparatus 100 in accordance with an embodiment of the present invention, FIG. 2 shows the construction of the data conversion apparatus in accordance with an embodiment of the present invention, FIG. 3 is a diagram showing a state in which an image displayed on a first screen according to a pixel processing unit of FIG. 2 has not been magnified, FIG. 4 is a detailed diagram showing the state of FIG. 3, FIG. 5 is a diagram showing a state in which an image of a first screen according to the pixel processing unit of FIG. 2 has been magnified, and FIG. 6 is a detailed diagram showing the state of FIG. 5.

Referring to FIGS. 1 to 6, the data conversion apparatus 100 includes the pixel processing unit 110 and a metadata processing unit 120.

First, the pixel processing unit 110 can perform a function of converting the size and number of pixels 10a so that the pixels 10a of an image 11 displayed on a first screen 10 having specific resolution (e.g., 480*320) can be displayed on a second screen 20 having different resolution (e.g., 960*640) as a plurality of pixels 10a′.

The number of pixels 10a of the first screen 10 may be one or more. The pixels 10a have various colors, thus displaying the image 11.

The image 11 displayed on the first screen 10 may be placed in a specific position of the first screen 10 or on the second screen 20 by means of the metadata processing unit 120.

Furthermore, the pixel processing unit 110 can perform a function of inserting the pixels 10a of the first screen 10 into the plurality of pixels 10a′ of the second screen 20 using a paging method.

The paging method may mean that each of the pixels 10a of the first screen 10 is divided according to a parameter determined in accordance with Equation below. For example, one pixel 10a may be divided into quartered, for example, 0 page, 1 page, 2 page, and 3 page.

Furthermore, the pixel processing unit 110 can perform a function of classifying the plurality of pixels 10a′ of the second screen 20 according to a parameter determined in accordance with Equation below.

V=R² [Equation]

In Equation, V is a parameter, and R is the conversion magnification of resolution of a second screen for resolution of a first screen.

In accordance with Equation, R is the conversion magnification of resolution of the second screen 20 for resolution of the first screen 10. For example, if the resolution of the second screen 20 is doubled as compared with the resolution of the first screen 10, R may correspond to 2, and the parameter V may correspond to 4.

For another example, if the resolution of the second screen 20 is trebled as compared with the resolution of the first screen 10, R may correspond to 3, and the parameter V may correspond to 9.

If the resolution of the second screen 20 is doubled in accordance with the above equation, the pixel processing unit 110 may group the plurality of pixels 10a′ of the second screen 20 by fours. If the resolution of the second screen 20 is trebled, the pixel processing unit 110 may group the plurality of pixels 10a′ of the second screen 20 in nines.

Here, assuming that the first screen 10 and the second screen 20 have the same size, if the resolution of the second screen 20 is doubled, four pixels 10a′ of the second screen 20 have the same size as one pixel 10a of the first screen 10 because the number of pixels is increased four times.

Referring to FIGS. 3 and 4, the size of one pixel 10a of the first screen 10 corresponds to four times the size of one pixel 10a′ of the second screen 20. If the resolution of the second screen 20 is doubled, the pixel processing unit 110 can automatically generate a non-magnifying group 10a″ by grouping four pixels 10a′ of the second screen 20.

Furthermore, the pixel processing unit 110 can copy the pixels 10a of the first screen 10 by fours and insert them into the non-magnifying groups 10a″. Accordingly, colors included in the pixels 10a of the first screen 10 can be identically implemented in the non-magnifying groups 10a″.

In general, if resolution is doubled, the size of the image 11 of the first screen 10 is reduced to ¼ because the number of pixels is relatively reduced to ¼. In this specification, however, the size of the image 11 is not reduced because the pixel processing unit 110 automatically generates the non-magnifying groups 10″.

As a result, if the image 11 of the first screen 10 is not magnified in FIG. 3, the pixels 10a′ of the second screen 20 are grouped by fours so that they have a size corresponding to that of the pixels 10a of the first screen 10, with the result that the non-magnifying groups 10a″ are formed. Accordingly, the image 11 of the first screen 10 may have the same size as the image 21 of the second screen 20.

An example in which the image 11 of the first screen 10 has not been magnified has been described above. An example in which the image 11 of the first screen 10 is magnified is described below with reference to FIGS. 5 and 6.

Referring to FIGS. 5 and 6, when the size of one pixel 10a of the first screen 10 corresponds to four times the size of one pixel 10a′ of the second screen 20 and the size of the image 11 of the first screen 10 is also increased four times, the number of pixels 10a′ of the second screen 20 is increased 16 times.

Accordingly, if, the size of the image 11 of the first screen 10 is increased four times because resolution is doubled, the pixel processing unit 110 automatically groups the non-magnifying groups 10a″ by fours.

Furthermore, the pixel processing unit 110 copies the pixels 10a of the first screen 10 by fours and insert them into respective four non-magnifying groups 10″. Here, the pixel processing unit 110 inserts an odd-numbered pixel 10a in width into a No. 0 non-magnifying group 10″, an even-numbered pixel 10a in width into a No. 1 non-magnifying group 10″, an odd-numbered pixel in width in the next column into a No. 2 non-magnifying group 10″, and an even-numbered pixels in width in the next column into a No. 3 non-magnifying group 10″. As a result, the size of the pixel 10a of the first screen 10 can be magnified four times in the second screen 20. Accordingly, colors included in the pixels 10a of the first screen 10 can be identically implemented in the four non-magnifying groups 10″.

Next, the metadata processing unit 120 can include one of position data regarding the pixel 10a of the first screen 10 or the pixel 10a′ of the second screen 20, motion data regarding motion information of the pixel 10a of the first screen 10 or the pixel 10a′ of the second screen 20, and physical dynamic data for implementing the motion information so that the pixel 10a of the first screen 10 is placed in the pixel 10a′ at a specific position of the second screen 20.

Here, the metadata is structured data regarding data in a common dictionary meaning, and the metadata may mean data indicating the attributes of corresponding data. In this specification, however, metadata may mean a unique coordinate value having the pixel 10a of the first screen 10 or the pixel 10a′ of the second screen 20.

For example, if metadata regarding the pixel 10a of the first screen 10 or the pixel 10a′ of the second screen 20 has not been defined, the pixels 10a and 10a′ may be displayed on the first screen 10 and the second screen 20, but positions at which the pixels 10a and 10a′ are placed on the first and the second screens 10 and 20 cannot be known.

Accordingly, the metadata processing unit 120 can set the positions of the pixels 10a and 10a′ on the first screen 10 and the second screen 20 by defining such metadata.

Such metadata is already known in the art, and thus a description thereof is omitted.

The data conversion apparatus 100 may further include a control unit 130 for controlling the flow of the pixel processing unit 110 and the metadata processing unit 120 in the middle of the flow.

As described above, the data conversion apparatus 100 according to the present invention performs a conversion function so that the pixels 10a of the image 11 displayed on the first screen 10 having low resolution can be inserted into the pixels 10a′ of the second screen 20 having high resolution. If the image 11 is sought not to be magnified, the data conversion apparatus 100 copies the pixels 10a of the first screen 10 in accordance with the above equation and inserts them into the pixels 10a′ of the second screen 20. If the image 11 is sought to be magnified, the data conversion apparatus 100 copies the non-magnifying groups 10a″ in accordance with the above equation, places them in the pixels 10a′ of the second screen 20, and inserts the pixels 10a of the first screen 10 into the non-magnifying groups 10″ in accordance with the aforementioned rule.

Accordingly, the data conversion apparatus 100 can display the image 11, displayed on the first screen 10 of low resolution, on the second screen 20 without distortion or a loss and use metadata used in the first screen 10 without an additional conversion process. Accordingly, the time that is taken for data conversion can be reduced.

In accordance with the data conversion apparatus and method according to the embodiments of the present invention, an image of low resolution is not magnified, but the number of one or more pixels of an image is changed in proportion to a resolution conversion magnification. Accordingly, there are advantages in that the size of an existing image remains intact if the image has not been magnified and an image can be magnified without being distorted if the image has been magnified.

Furthermore, in accordance with the present invention, metadata regarding game data used in a low-resolution screen is used without change without an additional conversion process. Accordingly, there is an advantage in that the time taken for a resolution conversion task can be reduced because information about the position of an image and a task for disposing screens are not necessary.

Furthermore, the present invention is advantageous in that the overall size of an image is not reduced because the size of a small pixel in a high-resolution screen is supplemented using a paging method and an image can be magnified or reduced although the size of a high-resolution screen is increased or reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data conversion apparatus, comprising:
a pixel processing unit for converting a size and number of pixels of an image displayed on a first screen having specific resolution so that the pixels are inserted into a plurality of pixels on a second screen having different resolution; and
a metadata processing unit for placing the image displayed on the first screen in the second screen so that the displayed image corresponds to a position in the first screen based on metadata of the pixels of the image displayed on the first screen.

2. The data conversion apparatus of claim 1, wherein the pixel processing unit inserts the pixels of the image, displayed on the first screen, into the plurality of pixels of the second screen using a paging method.

3. The data conversion apparatus of claim 2, wherein the pixel processing unit classifies the plurality of pixels of the second screen by grouping the plurality of pixels by a parameter determined in accordance with Equation below.
V=R² [Equation]
wherein V is the parameter, and R is a conversion magnification of resolution of the second screen for resolution of the first screen.

4. The data conversion apparatus of claim 3, wherein if the image is not magnified, the pixel processing unit generates one or more non-magnifying groups, corresponding to each of the pixels of the image displayed on the first screen, in the second screen based on the equation, copies each of the pixels of the image displayed on the first screen, and inserts the copied pixel into each of the non-magnifying groups.

5. The data conversion apparatus of claim 4, wherein if the image is to be magnified, the pixel processing unit copies each of pixels included in the non-magnifying group by an image magnification multiple and inserts the copied pixel into a plurality of pixels of the second screen.

6. The data conversion apparatus of claim 1, wherein the metadata processing unit comprises one or more of position data regarding one or more pixels that form the image displayed on the first screen, motion data regarding the motion information of the image, and physical dynamic data for implementing the motion information.

7. A data conversion method, comprising:
converting a size and number of pixels of an image displayed on a first screen having specific resolution so that the pixels are inserted into a plurality of pixels on a second screen having different resolution; and
placing the image displayed on the first screen in the second screen so that the displayed image corresponds to a position in the first screen based on metadata of the pixels of the image displayed on the first screen.

8. The data conversion method of claim 7, wherein the converting of the pixels of the image comprises inserting the pixels of the image, displayed on the first screen, into the plurality of pixels of the second screen using a paging method.

9. The data conversion method of claim 8, wherein the converting of the pixels of the image comprises classifying the plurality of pixels of the second screen by grouping the plurality of pixels by a parameter determined in accordance with Equation below.
v=R² [Equation]
wherein V is the parameter, and R is a conversion magnification of resolution of the second screen for resolution of the first screen.

10. The data conversion method of claim 9, wherein if the image is not magnified, the converting of the pixels of the image comprises generating one or more non-magnifying groups, corresponding to each of the pixels of the image displayed on the first screen, in the second screen based on the equation, copying each of the pixels of the image displayed on the first screen, and inserting the copied pixel into each of the non-magnifying groups.

11. The data conversion method of claim 10, wherein if the image is to be magnified, the converting of the pixels of the image comprises copying each of pixels included in the non-magnifying group by an image magnification multiple and inserts the copied pixel into a plurality of pixels of the second screen.
